(19) United States
(12) Patent Application Publication
(10) Pub. No.: US 2011/0013697 A1
(43) Pub. Date: Jan. 20, 2011

(54) MOTION VECTOR PREDICTION METHOD, AND APPARATUS AND METHOD FOR ENCODING AND DECODING IMAGE USING THE SAME

(75) Inventors: Woong-Il CHOI, Hwaseong-si (KR); Dae-Hee KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/839,488

(22) Filed: Jul. 20, 2010

(30) Foreign Application Priority Data
Jul. 20, 2009 (KR) 10-2009-0066103

(51) Int. Cl. H04N 7/32

(52) U.S. Cl. 375/240.16; 375/E07.125

(57) ABSTRACT

A method for predicting motion vectors to improve compressibility in an image compression codec which processes videos, and an image encoding/decoding apparatus and method using the same. A method for predicting a motion vector used during differential encoding of a motion vector for image encoding, the method including generating a motion vector list with candidate motion vectors for adjacent blocks of a target block, a predictive motion vector of which is to be obtained; calculating each distance between motion vectors included in the motion vector list; and determining a predictive motion vector for the target block by removing motion vectors in order of large distances between the motion vectors.

### CROSS-REFERENCE TO RELATED APPLICATIONS

This application claims the priority under 35 U.S.C. §119(a) of a Korean Patent Application No. 10-2009-0066103 filed in the Korean Intellectual Property Office on Jul. 20, 2009, the entire disclosure of which is hereby incorporated by reference.

### BACKGROUND

1. Field

The exemplary embodiments relate generally to an image encoding and decoding technology, and more particularly, to a method for predicting motion vectors to improve compressibility in an image compression codec which processes videos, etc., and an image encoding/decoding apparatus and method using the same.

2. Description of the Related Art

Generally, in a video compression technology, images are processed in units of macro blocks consisting of M×N pixel blocks. During video processing, macro blocks are encoded and decoded in any one of an intra mode and an inter mode. The macro block refers to a set of pixel blocks, which are set in a predetermined size, and one frame consists of a plurality of macro blocks. The typical video compression technology using the macro blocks may include compression standards such as MPEG and H.26x.

The basic concept of video compression is to remove the data which overlaps spatially and temporally, from the original image data. The intra mode is a scheme of removing the spatial redundancy, i.e., removing the redundancy between pixels in macro blocks of a predetermined size from the current frame. The inter mode is a scheme of removing the temporal redundancy, i.e., estimating the difference in macro block between the current frame and the previous or future reference frame, through motion estimation between corresponding macro blocks in two adjacent frames. The motion estimation is a process of searching for macro blocks in the reference frame, which are similar to macro blocks to be encoded in the current frame. During video encoding, motion compensation is performed using the macro blocks in the reference frame, which are found through the motion estimation. An image encoder entropy-encodes a difference between the found macro blocks in the reference frame and the macro blocks in the current frame along with a motion vector indicating the location of the reference frame, and transmits the results. Generally, the motion vector (MV) is defined as a displacement of the macro blocks found in the reference frame with respect to the macro blocks in the current frame.

Conventionally, for encoding of the MV, based on the feature that a correlation of an MV between a target macro block and its adjacent macro blocks is high, a so-called Predictive Motion Vector (PMV) is obtained from the adjacent macro blocks, and a Differential Motion Vector (DMV) between the PMV and the MV of the macro block is entropy-encoded. A process of obtaining the DMV by determining the PMV is called differential encoding.

Conventionally, the PMV is generally obtained by median values of MVs of adjacent macro blocks. For example, the PMV is obtained using MVs of 3 adjacent macro blocks in the left, top and top-right sides around a macro block given for calculation of median values.

FIG. 1 shows how to obtain a PMV in the related art, in which reference numeral 101 represents a target macro block, a DMV of which is to be obtained, and reference numerals 103 to 107 represent adjacent macro blocks used to obtain the PMV.

In FIG. 1, if a target macro block in which the MV to be encoded presently is located is assumed as a block E 101, MVs of a left block A 103, a top block B 105 and a top-right block C 107 around the block E 101 are used to obtain the PMV. Conventionally, an encoder (not shown) calculates a median value for each of x and y components of MVs of the 3 blocks 103, 105 and 107, and determines the median values as a PMV associated with the target macro block.

In the conventional technology described above, if blocks with no MV exist among adjacent macro blocks because of, for example, being encoded in the intra mode, i.e., if the number MVs used to obtain a PMV is less than 3, median values cannot be obtained, thus making it impossible to obtain a PMV associated with the target macro block. In addition, as described above, the MVs of the left block, the top block and the top-right block around the target macro block can be used to obtain a PMV. However, except for these MVs, MVs of other adjacent macro blocks, if any, may not be used at all.

Therefore, an alternative is required to easily obtain a PMV associated with a target macro block regardless of the number of adjacent macro blocks and the locations thereof.

### SUMMARY

An aspect of an exemplary embodiment is to address at least the above-mentioned problems and/or disadvantages and to provide at least the advantages described below. Accordingly, an aspect of an exemplary embodiment is to provide a motion vector prediction method capable of easily determining a predictive motion vector used during differential encoding of motion vectors.

Another aspect of an exemplary embodiment is to provide a motion vector prediction method for variably predicting motion vectors according to the number of adjacent blocks and the locations thereof.

A further another aspect of an exemplary embodiment is to provide an image encoding/decoding apparatus and method using the motion vector prediction method.

In accordance with one aspect of an exemplary embodiment, there is provided a method for predicting a motion vector used during differential encoding of a motion vector for image encoding, the method including generating a motion vector list with candidate motion vectors for adjacent blocks of a target block, a predictive motion vector of which is to be obtained; calculating each distance between motion vectors included in the motion vector list; and determining a predictive motion vector for the target block by removing motion vectors according to large distances between the motion vectors.

In accordance with another aspect of an exemplary embodiment, there is provided an image encoding apparatus for performing image encoding using a predictive motion vector, the apparatus including an image codec for encoding an input image according to a predetermined image encoding scheme; an entropy encoder for entropy-encoding motion vector information associated with an image encoded by the image codec; and a motion vector prediction unit for generating a motion vector list with candidate motion vectors for adjacent blocks of a target block, whose predictive motion vector for generation of the motion vector information is to be obtained, calculating each distance between mobile vectors included in the motion vector list, and determining a predictive motion vector for the target block by removing motion vectors according to large distances between the motion vectors.

In accordance with a further another aspect of an exemplary embodiment, there is provided an image decoding apparatus for performing image decoding using a predictive motion vector, the apparatus including an image codec for decoding an encoded image according to a predetermined image decoding scheme; an entropy decoder for entropy-decoding motion vector information associated with an image decoded by the image codec; and a motion vector prediction unit for generating a motion vector list with candidate motion vectors for adjacent blocks of a target block, a predictive motion vector of which is to be obtained, the predictive motion vector being used to calculate a motion vector for the target block of an image by being added to the motion vector information, calculating each distance between motion vectors included in the motion vector list, and determining a predictive motion vector for the target block by removing motion vectors according to large distances between the motion vectors.

### BRIEF DESCRIPTION OF THE DRAWINGS

The above and other aspects, features and advantages of certain exemplary embodiments will be more apparent from the following description taken in conjunction with the accompanying drawings, in which:

FIG. 1 is a diagram showing how to obtain a PMV in the related art;

FIGS. 2 to 6 are diagrams showing various examples for the locations of adjacent blocks used to obtain a PMV associated with a target block according to an exemplary embodiment;

FIG. 7 is a diagram showing a format of a table in which MVs in an MV list are mapped to locations of adjacent blocks according to an exemplary embodiment;

FIG. 8 is a flowchart showing a process of determining (predicting) a PMV for entropy encoding according to an exemplary embodiment;

FIG. 9 is a block diagram showing a structure of an image encoder to which a motion vector prediction method is applied, according to an exemplary embodiment; and

FIG. 10 is a block diagram showing a structure of an image decoder to which a motion vector prediction method is applied, according to an exemplary embodiment.

### DETAILED DESCRIPTION OF EXEMPLARY EMBODIMENTS

Exemplary embodiments will now be described in detail with reference to the accompanying drawings. In the following description, specific details such as detailed configuration and components are merely provided to assist the overall understanding of exemplary embodiments. In addition, descriptions of well-known functions and constructions are omitted for clarity and conciseness.

First, the terms used herein will be defined in brief. The term “block” as used herein shall be construed to include an M×N macro block, and each of a plurality of pixel blocks constituting the macro block. For example, a 16×16 macro block may consist of 4 8×8 pixel blocks.

In the conventional technology described above, a PMV is obtained in units of macro blocks. However, in exemplary embodiments, a PMV can be obtained not only in units of macro blocks, but also in units of pixel blocks constituting the macro block. Therefore, the term “adjacent block” as used herein may refer to adjacent macro blocks around a target block, a PMV of which is to be obtained, or pixel blocks in the adjacent macro blocks. In addition, if a target block is a macro block, a PMV can be obtained using not only adjacent macro blocks but also pixel blocks in the adjacent macro blocks, and if a target block is a pixel block in a macro block, a PMV may be obtained using pixel blocks in adjacent macro blocks.

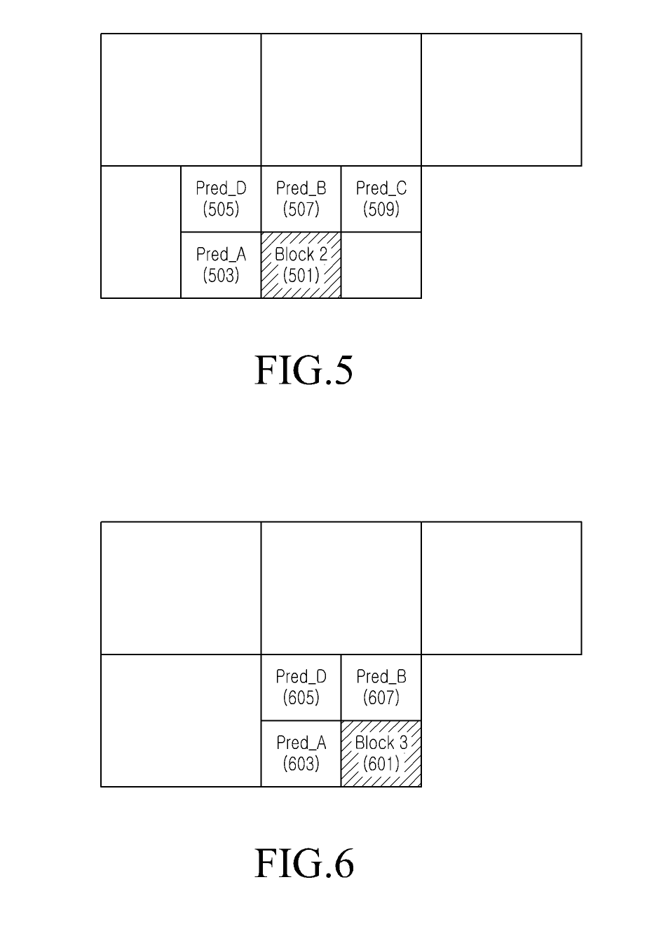

FIGS. 2 to 6 show various examples for the locations of adjacent blocks used to obtain a PMV associated with a target block according to an exemplary embodiment.

It is assumed in the examples of FIGS. 2 to 6 that a macro block has a size of a 16×16 block, and each pixel block in the macro block has a size of an 8×8 block. However, the sizes of the macro blocks and the pixel blocks are subject to change.

First, FIG. 2 shows an example in which if a target block is a macro block, pixel blocks 203-211 in adjacent macro blocks are used as adjacent blocks of a target macro block 201. Conventionally, 3 adjacent blocks are used on a fixed basis in determining a PMV using median values. In the exemplary embodiment, however, a PMV may be obtained using more than 3 adjacent blocks located as shown in FIG. 2.

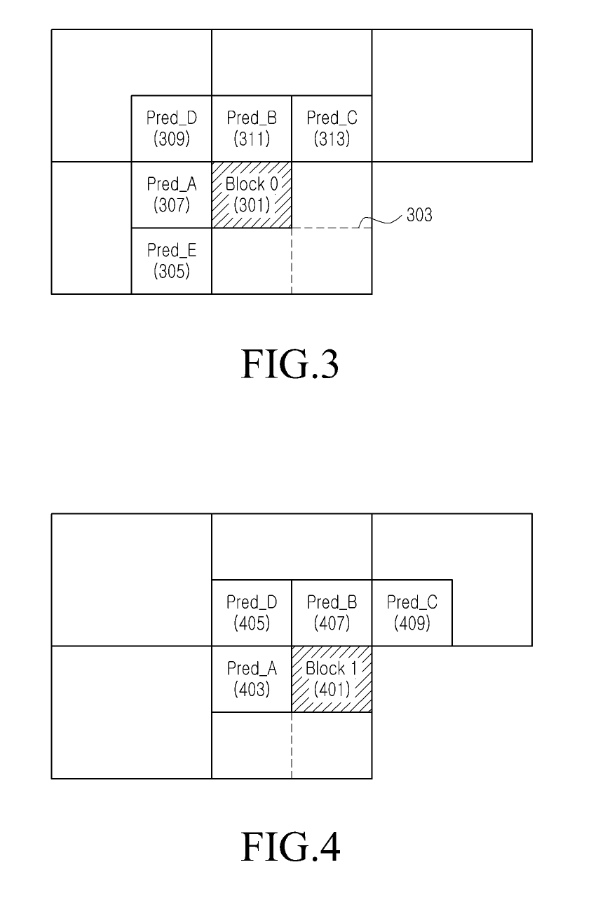

FIGS. 3 to 6 show examples in which if a target block is a pixel block in a macro block, pixel blocks in adjacent macro blocks are used as adjacent blocks. Thus, adjacent blocks in various locations may be used to obtain a PMV, depending on the locations of target blocks 301, 401, 501 and 601 in a macro block.

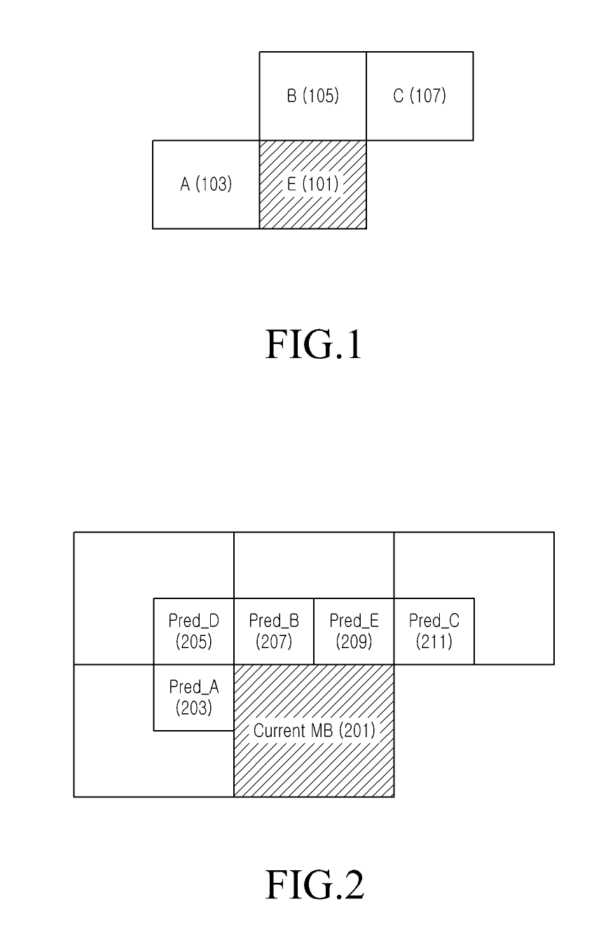

In the example of FIG. 3, the locations of adjacent blocks 305-313 are shown for the case where 5 adjacent blocks 305-313 are used to obtain a PMV, showing that even a left-bottom adjacent block 305 of a target block 301 may be used to obtain the PMV. The examples of FIGS. 4 to 6 also show that adjacent blocks 403-409, 503-509, and 603-607 can be selected to have various locations according to the locations of target blocks 401, 501 and 601, unlike the locations of the adjacent blocks described in the related art of FIG. 1. It can be seen from the examples of FIGS. 2 to 6 that the exemplary embodiment determines a PMV associated with a target block without restricting not only the number of adjacent blocks used for PMV decision, but also the sizes and locations of target blocks and adjacent blocks.

Rather than being determined arbitrarily, the sizes and locations of target blocks and adjacent blocks, described in the examples of FIGS. 2 to 6, are determined through experiments to obtain optimal PMVs for the target blocks. However, the sizes and locations of target blocks and adjacent blocks are not necessarily limited to the examples of FIGS. 2 to 6, but instead, they may be appropriately modified as long as a motion vector prediction method of the exemplary embodiment, to be described blow, is applicable.

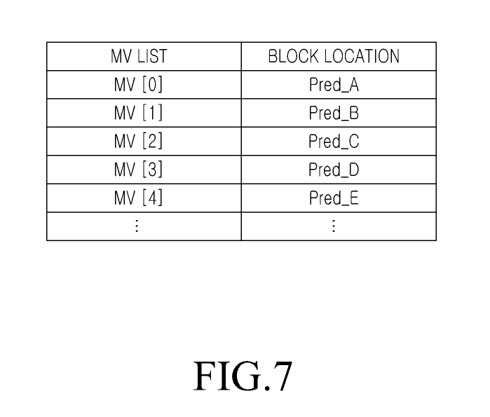

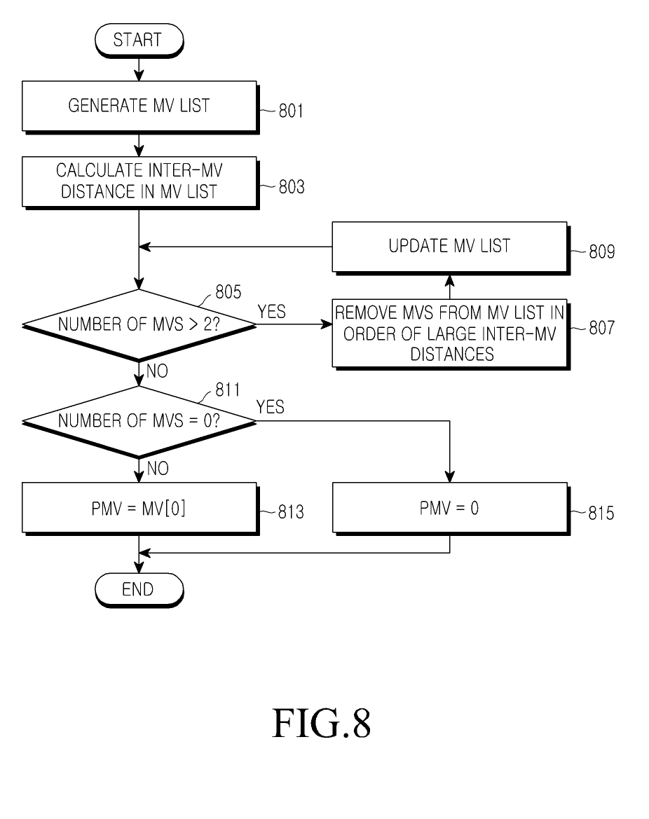

With reference to FIGS. 7 and 8, a description will now be made of a motion vector prediction method according to an exemplary embodiment, which obtains a PMV associated with a target block by listing MVs of adjacent blocks in order of high to low correlations with an MV of the target block. The motion vector prediction method may be applied to a variety of image encoders/decoders that perform encoding and decoding using motion vectors according to the inter mode.

FIG. 7 shows an exemplary format of a table in which MVs in an MV list are mapped to locations of adjacent blocks according to an exemplary embodiment.

In the mapping table of FIG. 7, the left field represents MVs of adjacent blocks, which are listed in order of high to low probabilistic correlations with an MV of a target block, and the right field represents the locations Pred_A-Pred_E of the adjacent blocks, which are mapped to the listed MVs.

For example, if an adjacent block having an MV, whose correlation with the current target block's MV is highest, is assumed as a left block Pred_A of the target block, the left block Pred_A is mapped to a 0^{th} motion vector MV[0]. In this manner, an MV list is generated by ordering MVs of adjacent blocks in order of high to low probabilistic correlations, and then a PMV associated with the target block is determined in the generated MV list. If no motion vector exists in a particular adjacent block, the adjacent block is not included in the MV list. For example, in the mapping table of FIG. 7, if Pred_A and Pred_B have no MV as they are encoded in the intra mode, then the MV list is generated in such a manner that Pred_A and Pred_B are not included in the mapping table, Pred_C is mapped to MV[0], and Pred_D is mapped to MV[1].

FIG. 8 shows a process of determining (predicting) a PMV for entropy encoding according to an exemplary embodiment, in which a PMV associated with a target block is determined by removing MVs from the MV list according to large calculated distance values between MVs.

In step 801, an image encoder/decoder receives an MV list generated by listing MVs of adjacent blocks in the manner of FIG. 7, for PMV decision. The maximum number of MVs that can be used in the MV list for PMV decision is assumed to be a value N predetermined in the image encoder/decoder. Hence, the MV list will consist of a maximum of N motion vectors MV[0], MV[1], . . . , MV[N−1].

The image encoder/decoder calculates an inter-MV distance for each of MVs in the MV list in step 803, and determines whether in step 805 whether the current number of MVs in the MV list is greater than 2. If the current number of MVs is greater than 2 in step 805, the image encoder/decoder removes the MVs with large calculated distances from the MV list in step 807, and updates the MV list in step 809.

While the process of removing the MVs in step 807 and the process of updating the MV list in step 809 have been separately shown in FIG. 8, step 809 may be omitted because the MV list may be automatically updated when the MVs are removed in step 807.

Regarding the calculation of inter-MV distances, the image encoder/decoder calculates inter-MV distances using Equation (1) below, for x-axis components and y-axis components of MVs.

Dist_{—}x[k]=|MV_{—}x[k]−MV_{—}x[k+1]|Dist_{—}y[k]=|MV_{—}y[k]−MV_{—}y[k+1]| (1)

where Dist_x[k] represents an x-axis distance component between two adjacent MVs in the MV list, and Dist_y[k] represents a y-axis distance component between the two adjacent MVs. It can be noted that Equation (1) is for calculating a distance between a k-th MV and a (k+1)-th MV, and the inter-MV distance is determined by calculating a distance between adjacent MVs in the MV list.

A distance Dist[k] between MVs in the MV list is calculated using Equation (1), and then two MVs with a large Dist[k] are removed from the MV list. For example, if Dist[k] is the largest, MV[k] and MV[k+1] are removed from the MV list. By removing the two MVs with the largest Dist[k] from the current MV list in this way, the MV list is updated.

The operation in steps 805 through 809 is repeated until the number MVs in the MV list is less than or equal to 2. By this operation, it is possible to determine (predict) a PMV using the MV list consisting of the shortest-distance MVs.

If the number of remaining MVs in the MV list is less than or equal to 2 in step 805, the image encoder/decoder determines in step 811 whether there are any remaining MVs in the MV list. If there are remaining MVs in step 811, the image encoder/decoder determines MV[0] as a PMV in the MV list of FIG. 7 in step 813. However, if there is no remaining MV in step 811, the image encoder/decoder determines a PMV as 0.

The processes of FIG. 8 are performed on x and y components of MVs separately. In other words, a series of processes of updating an MV list based on distances from an input MV list and determining a PMV are performed on x and y components individually.

Table 1 below shows an exemplary construction of a program code in a case where a PMV is determined using only a maximum of 3 MVs are used in the MV list of FIG. 7. In this case, the maximum number N of MVs included in the MV list is 3. Thus, a PMV is determined by comparing Dist[0] indicating a distance between MV[0] and MV[1] with Dist[1] indicating a distance between MV[1] and MV[2]. If Dist[0] is less than Dist[1], MV[0] is determined as a PMV since MV[1] and MV[2] are removed from the MV list. Conversely, if Dist[0] is greater than Dist[1], MV[0] and MV[1] are removed from the MV list, and MV[2] becomes MV[0] during update of the MV list. Eventually, a motion vector used as a PMV is MV[2].

```
TABLE 1
if (N == 0){
  PMVx = 0
  PMVy = 0
}
else if (N < 3){
  PMVx = MVx[0]
  PMVy = MVy[0]
}
else {
    if ( | MVx [0] - MVx [1]| < | MVx [1] - MVx [2]| )
      PMVx = MVx [0]
    else
      PMVx = MVx [2]
    if ( | MVy [0] - MVy [1]| < | MVy [1] - MVy [2]| )
      PMVy = MVy [0]
    else
      PMVy = MVy [2]
}
```

In conclusion, according to exemplary embodiments, a PMV associated with a target block may be determined without restricting not only the number of adjacent blocks but also the sizes and locations of target blocks and adjacent blocks.

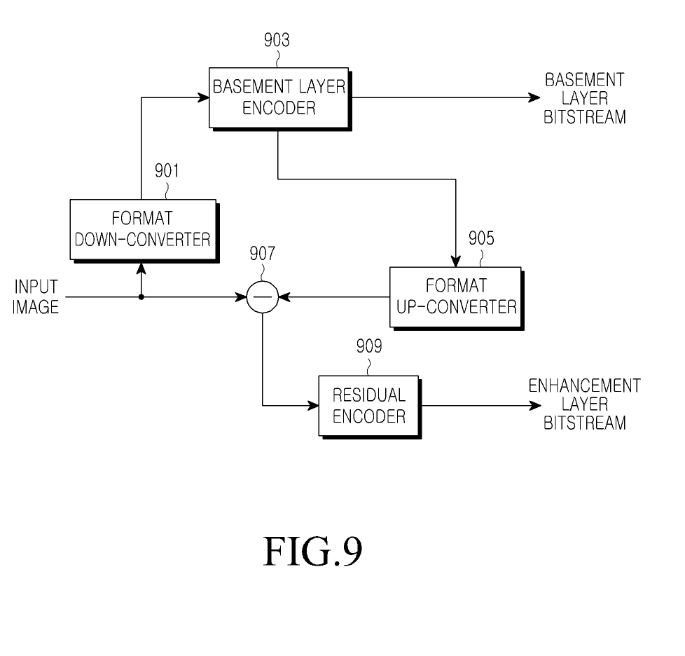

FIG. 9 shows a structure of an image encoder to which a motion vector prediction method is applied, according to an exemplary embodiment.

The image encoder of FIG. 9, constructed in a hierarchical structure including a basement layer and an enhancement layer, encodes an input image and outputs a basement layer bitstream and an enhancement layer bitstream. An image of the basement layer and an image of the enhancement layer may have different resolutions, image sizes, and view points.

It is assumed in the example of FIG. 9 that the input image and the image processed in the enhancement layer have high resolutions, large sizes and one view point, while the image processed in the basement layer has a low resolution, a small size and another view point. A format down-converter 901 down-converts the input image into an image format of the basement layer. A basement layer encoder 903 encodes the input basement layer image according to the existing encoding scheme using one of the existing video codecs such as VC-1, H.264, MPEG-4 Part 2 Visual, MPEG-2 Part 2 Video, AVS and JPEG2000, and outputs the encoded image in a basement layer bitstream. The basement layer encoder 903 outputs the basement layer image reconfigured in the basement layer image encoding process, to a format up-converter 905.

The format up-converter 905 up-converts the reconfigured basement layer image into an image format of the enhancement layer. The input image being input to the format down-converter 901 is input to a subtractor 907 as well. The subtractor 907 outputs residual data obtained by subtracting the up-converted image from the input image, and a residual encoder 909 residual-encodes the input residual data, and outputs the encoded data in an enhancement layer bitstream.

The format down-converter 901 and the format up-converter 905 each include means for determining a PMV in the relevant layer according to the motion vector prediction method described in FIGS. 2 to 8 during video processing in the inter mode. The determined PMV is used to calculate a DMV, a kind of input information, during entropy encoding. The means for determining a PMV according to the motion vector prediction method may be included as a separate component.

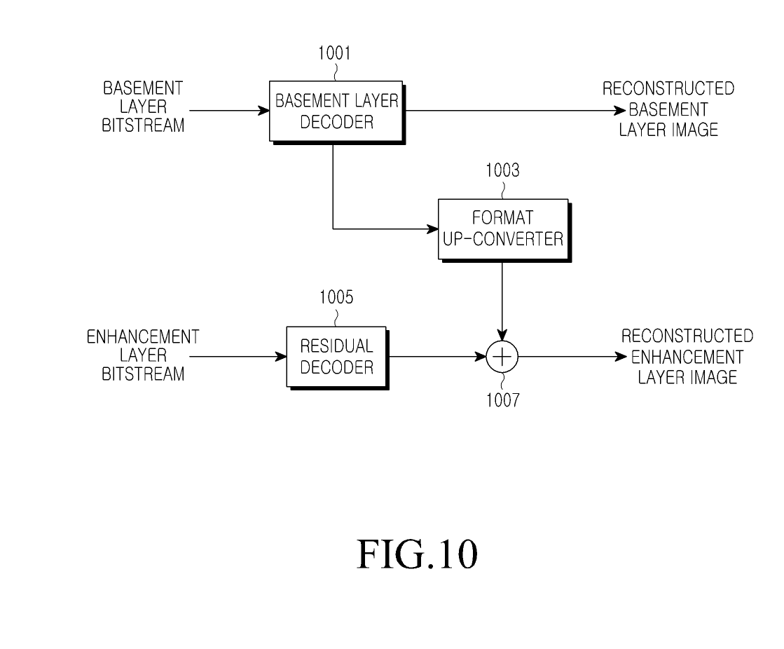

FIG. 10 shows a structure of an image decoder to which a motion vector prediction method is applied, according to an exemplary embodiment.

The image decoder of FIG. 10, constructed in a hierarchical structure including a basement layer and an enhancement layer, decodes the basement layer bitstream and the enhancement layer bitstream, which have been encoded by the encoder of FIG. 9, and outputs a reconfigured basement layer image and a reconfigured enhancement layer image. The basement layer image and the enhancement layer image may have different resolutions, image sizes and view points.

It is assumed in the example of FIG. 10 that the input image and the image processed in the enhancement layer have high resolutions, large sizes and one view point, while the image processed in the basement layer has a low resolution, a small size and another view point. A basement layer decoder 1001 decodes the input basement layer bitstream using a decoding scheme corresponding to the video codec used in the basement layer encoder 901 in FIG. 9, and outputs a reconfigured basement layer image. The basement layer image reconfigured by the basement layer decoder 1001 is output to a format up-converter 1003 as well. The format up-converter 1003 up-converts the reconfigured basement layer image into an image format of the enhancement layer. A residual decoder 1005 outputs a residual image by residual-decoding the input enhancement layer bitstream, and the residual image is added to the up-converted image by an adder 1007, and then output as a reconfigured enhancement layer image.

The format up-converter 1003 includes means for determining a PMV in the relevant layer according to the motion vector prediction method described in FIGS. 2 to 8 during video processing in the inter mode. The determined PMV is used to obtain a MV of a target block by being added to a DMV after undergoing entropy encoding. The means for determining a PMV according to the motion vector prediction method may be included as a separate component.

The hierarchical encoder/decoder to which the motion vector prediction method of the exemplary embodiment is applied has been described in conjunction with FIGS. 9 and 10, and the proposed motion vector prediction method may be applied to various image encoders/decoders using motion vectors, including MPEG x and H.26x standards.

In this case, an image encoding apparatus includes an image codec for encoding an input image according to a predetermined image encoding scheme, an entropy encoder for entropy-encoding motion vector information (i.e., a DMV of a target block) associated with the image encoded by the image codec, and means (i.e., a motion vector prediction unit) for determining (predicting) a PMV according to the examples of FIGS. 2 to 8. An image decoding apparatus includes an image codec for decoding the encoded image according to a predetermined image decoding scheme, an entropy decoder for entropy-decoding motion vector information (i.e., a DMV of a target block) associated with the image decoded by the image codec, and means (i.e., a motion vector prediction unit) for determining (predicting) a PMV according to the examples of FIGS. 2 to 8.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for predicting a motion vector used during differential encoding of a motion vector for image encoding, the method comprising:
generating a motion vector list including motion vectors for adjacent blocks of a target block;
calculating distances between motion vectors in the motion vector list; and
determining a predictive motion vector for the target block by removing at least one of the motion vectors in order of large distances between the motion vectors according to the calculated distances.

2. The method of claim 1, wherein the determining the predictive motion vector comprises repeating the operation of removing two of motion vectors according to the calculated distances between the motion vectors until a number of remaining motion vectors in the motion vector list is less than or equal to a predetermined number.

3. The method of claim 2, wherein the predetermined number is 2.

4. The method of claim 2, further comprising determining the predictive motion vector as zero (0) if the number of remaining motion vectors is 0.

5. The method of claim 1, wherein the removing two of the motion vectors comprises comparing a first distance between a first pair of adjacent motion vectors in the motion vector list with a second distance between a second pair of adjacent motion vectors in the motion vector list.

6. The method of claim 5, wherein the determining the predictive motion vector comprises removing one of the first and the second pairs of adjacent motion vectors having the corresponding one of the first and the second distances that is larger than another of the first and the second distances, from the motion vector list.

7. The method of claim 1, wherein the determining the predictive motion vector comprises successively removing two motion vectors corresponding to the largest distance between motion vectors, from the motion vector list.

8. The method of claim 1, wherein the target block is any one of a macro block and a pixel block in the macro block.

9. The method of claim 1, wherein the adjacent blocks are pixel blocks in adjacent macro blocks of the target block.

10. The method of claim 1, wherein the adjacent blocks are greater than or equal to 3 in number.

11. An image encoding apparatus for performing image encoding using a predictive motion vector, the apparatus comprising:
an image codec which encodes an input image according to a predetermined image encoding scheme;
an entropy encoder which entropy encodes motion vector information associated with an image encoded by the image codec; and
a motion vector prediction unit which generates a motion vector list including motion vectors for adjacent blocks of a target block, calculates distances between mobile vectors included in the motion vector list, and determines a predictive motion vector for the target block for generation of the motion vector information, by removing at least one of the motion vectors in order of large distances between the motion vectors according to the calculated distances.

12. The image encoding apparatus of claim 11, wherein the motion vector prediction unit repeats the operation of removing two of the motion vectors according to the calculated distances between the motion vectors until a number of remaining motion vectors in the motion vector list is less than or equal to a predetermined number.

13. The image encoding apparatus of claim 11, wherein the motion vector prediction unit removes two of the motion vectors by comparing a first distance between a first pair of adjacent motion vectors in the motion vector list with a second distance between a second pair of adjacent motion vectors in the motion vector list.

14. The image encoding apparatus of claim 13, wherein the motion vector prediction unit is adapted to remove one of the first and the second pairs of adjacent motion vectors having the corresponding one of the first and the second distances that is larger than another of the first and the second distances, from the motion vector list.

15. The method of claim 11, wherein the motion vector prediction unit is adapted to successively remove two motion vectors corresponding to the largest distance between motion vectors, from the motion vector list.

16. The image encoding apparatus of claim 11, wherein the target block is any one of a macro block and a pixel block in the macro block.

17. The image encoding apparatus of claim 11, wherein the adjacent blocks are pixel blocks in adjacent macro blocks of the target block.

18. An image decoding apparatus for performing image decoding using a predictive motion vector, the apparatus comprising:
an image codec which decodes an encoded image according to a predetermined image decoding scheme;
an entropy decoder which entropy-decodes motion vector information associated with an image decoded by the image codec; and
a motion vector prediction unit which generates a motion vector list including motion vectors for adjacent blocks of a target block, calculates distances between motion vectors included in the motion vector list, and determines a predictive motion vector for the target block for generation of the motion vector information, by removing at least one of the motion vectors in order of large distances between the motion vectors according to the calculated distances.

19. The image decoding apparatus of claim 18, wherein the motion vector prediction unit repeats the operation of removing two of the motion vectors according to the calculated distances between the motion vectors until a number of remaining motion vectors in the motion vector list is less than or equal to a predetermined number.

20. The image decoding apparatus of claim 18, wherein the motion vector prediction unit removes two of the motion vectors by comparing a first distance between a first pair of adjacent motion vectors with a second distance between second pair of adjacent motion vectors in the motion vector list.

21. The image decoding apparatus of claim 20, wherein the motion vector prediction unit is adapted to remove one of the first and the second pairs of adjacent motion vectors having the corresponding one of the first and the second distances that is larger than another of the first and the second distances, from the motion vector list.

22. The method of claim 18, wherein the motion vector prediction unit is adapted to successively remove two motion vectors corresponding to the largest distance between motion vectors, from the motion vector list.

23. The image decoding apparatus of claim 18, wherein the target block is any one of a macro block and a pixel block in the macro block.

24. The image decoding apparatus of claim 18, wherein the adjacent blocks are pixel blocks in adjacent macro blocks of the target block.
